(19) United States
(12) Patent Application Publication
(10) Pub. No.: US 2021/0093982 A1
(43) Pub. Date: Apr. 1, 2021

(54) SEAWATER DESALINATION SYSTEM

(71) Applicant: Guangdong University of Technology, Guangzhou (CN)

(72) Inventors: Ying CHEN, Guangzhou (CN); Jianyong CHEN, Guangzhou (CN); Junjie LI, Guangzhou (CN); Xianglong LUO, Guangzhou (CN); Yingzong LIANG, Guangzhou (CN); Zhi YANG, Guangzhou (CN)

(21) Appl. No.: 16/899,697

(22) Filed: Jun. 12, 2020

(30) Foreign Application Priority Data
Sep. 27, 2019 (CN) 201910925738.1

(51) Int. Cl. B01D 1/00; B01D 5/00; C02F 1/04; C02F 1/14

(52) U.S. Cl. CPC B01D 1/0035; B01D 1/0082; C02F 2103/08; C02F 1/043; C02F 1/14; B01D 5/006

(57) ABSTRACT

A seawater desalination system includes an evaporation tank, a heat absorption device, a first pipeline, a second pipeline, a condenser, a third pipeline, a water tank and a solar cell panel. A first closed cavity for containing seawater is provided in the evaporation tank. A first and a second through hole are provided in an inner side wall of the first closed cavity. The heat absorption device is provided in the evaporation tank, and a light inlet of the heat absorption device is opposite to the light absorption surface. A first end of the first pipeline is connected to a liquid supply device of seawater, and a second end thereof is connected to the first through hole. A first end of the second pipeline is connected to the second through hole, a second end thereof is connected to the condenser. The condenser is connected to the water tank.

### CROSS REFERENCE TO RELATED APPLICATION

This application claims the priority of Chinese Patent Application No. 201910925738.1, entitled “Seawater Desalination System” filed with the Chinese Patent Office on Sep. 27, 2019, which is incorporated herein by reference in its entirety.

### TECHNICAL FIELD

The present application relates to the technical field of seawater desalination treatment, in particular to a seawater desalination system.

### BACKGROUND ART

With the development of economy and the increase of population, the demand of human beings on water resources is continuously increasing, and the unreasonable exploitation and uneven distribution of water resources lead to the problems of the water resource shortage in many areas. Although the sea contains a large amount of water source, because of the variety and high content of salt in the seawater, it cannot be used directly because it exceeds the physiological needs of human beings, so the seawater needs to be desalinated before it can be used.

The existing seawater desalination system utilizes high-grade energy, like electricity, to desalinate seawater. Moreover, the existing solar energy driven seawater desalination system only utilizes solar energy to provide electric energy for the seawater desalination system, and the utilization of solar energy is inefficient.

### SUMMARY OF THE INVENTION

In view of this, the present application provides a seawater desalination system, which is used for solving the technical problem of the relatively inefficient solar energy utilization of the existing seawater desalination system.

The present application provides a seawater desalination system having an evaporation tank, a heat absorption device, a first pipeline, a second pipeline, a condenser, a third pipeline, a water tank and a solar cell panel.

A first closed cavity for containing seawater is provided in the evaporation tank. A first through hole and a second through hole are provided in an inner side wall of the first closed cavity, and a light absorption surface of the evaporation tank is made of a high-light-transmission material.

The heat absorption device is provided in the evaporation tank and used for absorbing sunlight with a wavelength of no less than 1100 nm. A light inlet of the heat absorption device is provided opposite to the light absorption surface of the evaporation tank 1.

A first end of the first pipeline is connected to a liquid supply device of seawater, and a second end of the first pipeline is connected to the first through hole.

A first end of the second pipeline is connected to the second through hole. A second end of the second pipeline is connected to the condenser. The second pipeline is used for conveying water vapor evaporated by seawater in the evaporation tank.

The condenser is connected to the water tank through the third pipeline.

The solar cell panel is used for providing electric energy for the heat absorption device and the condenser.

Optionally, the seawater desalination system further includes a first heater. The first heater is provided in the evaporation tank and externally connected with a power supply.

Optionally, the seawater desalination system further comprises a fourth pipeline, a first controller and a first liquid storage tank. A third through hole is provided in the inner side wall of the first closed cavity. A first end of the fourth pipeline is connected to the third through hole, and a second end of the fourth pipeline is connected to the first liquid storage tank. The first controller is arranged on the fourth pipeline and used for controlling opening and closing of the fourth pipeline.

Optionally, the seawater desalination system further includes a heat storage tank, a fifth pipeline, a sixth pipeline, a second controller, a first heat exchanger and a seventh pipeline. A second closed cavity for containing seawater is provided in the heat storage tank. A fourth through hole, a fifth through hole and a sixth through hole are provided in an inner side wall of the second closed cavity. A first end of the fifth pipeline is connected to the liquid supply device, and a second end of the fifth pipeline is connected to the fourth through hole. A first end of the sixth pipeline is connected to the first liquid storage tank, and a second end of the sixth pipeline is connected to the fifth through hole. The second controller is arranged on the sixth pipeline and used for controlling opening and closing of the sixth pipeline. The first heat exchanger is provided in the heat storage tank and is connected to the fifth through hole and used for conducting heat of seawater in the sixth pipeline to the heat storage tank. A first end of the seventh pipeline is connected to the sixth through hole, and a second end of the seventh pipeline is connected to the condenser. The seventh pipeline is used for conveying water vapor evaporated by seawater in the heat storage tank.

Optionally, the seawater desalination system further includes an eighth pipeline. A seventh through hole is provided in the inner side wall of the second closed cavity. The eighth pipeline is connected to the first heat exchanger through the seventh through hole and used for discharging seawater in the sixth pipeline.

Optionally, the seawater desalination system further includes a ninth pipeline and a heat storage device. An eighth through hole is provided in the inner side wall of the second closed cavity. A first end of the ninth pipeline is connected to the second pipeline, and a second end of the ninth pipeline is connected to the eighth through hole. The heat storage device is provided in the heat storage tank and used for absorbing heat of the water vapor and seawater in the heat storage tank is heated and evaporated by using the absorbed heat.

Optionally, the liquid supply device includes a second liquid storage tank and a tenth pipeline. A water outlet of the second liquid storage tank is connected to the first end of the first pipeline. A first end of the tenth pipeline is connected to a water inlet of the second liquid storage tank 2.

Optionally, the seawater desalination system further includes a second heat exchanger. A first end of the second heat exchanger is connected to a second end of the tenth pipeline, and a second end of the second heat exchanger is connected to an input end of the condenser, the second heat exchanger is used for conducting heat of water vapor before entering the condenser to seawater in the tenth pipeline.

Optionally, the seawater desalination system further includes an eleventh pipeline and a second heater. A first end of the eleventh pipeline is connected to the second liquid storage tank. An input end of the second heater is connected to a second end of the eleventh pipeline, and an output end of the second heater is connected to the first end of the first pipeline.

Optionally, the solar cell panel is provided above the evaporation tank and a back plate of the solar cell panel is made of a high-light-transmission material. The back plate of the solar cell panel is provided opposite to the light absorption surface of the evaporation tank.

It can be seen from the above technical solutions that the present application has the following advantages:

The present application discloses a seawater desalination system having an evaporation tank, a heat absorption device, a first pipeline, a second pipeline, a condenser, a third pipeline, a water tank and a solar cell panel. A first closed cavity for containing seawater is provided in the evaporation tank. A first through hole and a second through hole are provided in an inner side wall of the first closed cavity, and a light absorption surface of the evaporation tank is made of a high-light-transmission material. The heat absorption device is provided in the evaporation tank and used for absorbing sunlight with a wavelength of no less than 1100 nm, and a light inlet of the heat absorption device is provided opposite to the light absorption surface of the evaporation tank. A first end of the first pipeline is connected to a liquid supply device of seawater, and a second end of the first pipeline is connected to the first through hole. A first end of the second pipeline is connected to the second through hole, and a second end of the second pipeline is connected to the condenser 5. The second pipeline is used for conveying water vapor evaporated by seawater in the evaporation tank. The condenser is connected to the water tank through the third pipeline. The solar cell panel is used for providing electric energy for the heat absorption device and the condenser.

The evaporation tank is internally provided with the first closed cavity used for containing seawater. The inner side wall of the first closed cavity is provided with the first through hole and the second through hole. The light absorption surface of the evaporation tank is made of a high-light-transmission material, which can allow sunlight to be fully transmitted into the evaporation tank. The heat absorption device is arranged in the evaporation tank and used for absorbing sunlight with the wavelength of no less than 1100 nm, and the light inlet of the heat absorption device is provided opposite to the light absorption surface 27 the evaporation tank, so that the heat absorption device can absorb sunlight with the wavelength of no less than 1100 nm and seawater is evaporated by utilizing the heat of the sunlight with the wavelength of no less than 1100 nm. The first end of the first pipeline is connected to the liquid supply device of seawater, and the second end of the first pipeline is connected to the first through hole. The first end of the second pipeline is connected to the second through hole, and the second end of the second pipeline is connected to the condenser. The second pipeline is used for conveying water vapor evaporated by seawater in the evaporation tank. The condenser is connected to the water tank through the third pipeline, and the seawater enters the evaporation tank through the first pipeline to be heated and evaporated and then enters the condenser to be condensed through the second pipeline, and finally is collected into the water tank, so that water resources can be saved. The solar cell panel is used for providing electric energy for the heat absorption device and the condenser. The solar cell panel is used for converting sunlight into electric energy, so that the effect of saving energy can be achieved. Compared with the mode that only electric energy is provided in the traditional seawater desalination system, the present application not only utilizes the short wave band in sunlight to provide electric energy for equipment in the system, but also utilizes the long wave band in sunlight to evaporate seawater, so that the utilization rate of solar energy is effectively improved, and the technical problem that the utilization rate of solar energy is low in the existing seawater desalination system is solved.

### BRIEF DESCRIPTION OF THE DRAWINGS

FIG. 1 is a structural schematic diagram of a seawater desalination system provided in an embodiment of the present application;

FIG. 2 is a structural schematic diagram of an evaporation tank provided in the embodiment of the present application;

Wherein, the reference numerals are as follows:

1, evaporation tank; 2, heat absorption device; 3, first pipeline; 4, second pipeline; 5, condenser; 6, third pipeline; 7, water tank; 8, solar cell panel; 9, first heater; 10, fourth pipeline; 11, first controller; 12, first liquid storage tank; 13, heat storage tank; 14, fifth pipeline; 15, sixth pipeline; 16, second controller; 17, first heat exchanger; 18, seventh pipeline; 19, eighth pipeline; 20, ninth pipeline; 21, heat storage device; 22, second liquid storage tank; 23, tenth pipeline; 24, second heat exchanger; 25, eleventh pipeline; 26, second heater; 27, light absorption surface; 28, first insulating layer.

### DETAILED DESCRIPTION OF THE EMBODIMENTS

In order that the objects, features, and advantages of the present application may be more fully apparent and readily understood, the technical solutions in embodiments of the present application will be clearly and completely described below with reference to the accompany drawings in embodiments of the present application. It is to be understood that the embodiments described below are only a part of the embodiments of the present application, and not all embodiments. Based on the embodiments in the present application, all other embodiments obtained by those skilled in the art without making any inventive effort belong to the scope of protection of the present application.

In the description of the embodiments of the present application, it should be noted that the terms “center”, “upper”, “lower”, “left”, “right”, “vertical”, “horizontal”, “inner”, “outer”, and the like indicate orientations or positional relationships based on the orientations or positional relationships shown in the drawings, and are merely intended to facilitate describing the embodiments of the present application and to simplify the description, rather than to indicate or imply that the referenced devices or elements must have a particular orientation, or be constructed and operated in a particular orientation. Thus, they should not be construed as limiting the embodiments of the present application. Furthermore, the terms “first”, “second”, and “third” are used for descriptive purposes only and are not to be construed as indicating or implying relative importance.

In describing the embodiments of the present application, it is to be noted that the terms “mounted”, “connected with”, and “connected to”, unless otherwise explicitly stated or limited, are intended to be broadly construed as being, for example, either fixedly connected, interchangeably connected, integrally connected, mechanically connected, electrically connected, or directly connected. It may also be indirectly connected through an intermediate medium and may be an internal communication between the two elements. The specific meanings of the above terms in the embodiments of the present application will be understood by those of ordinary skill in the art according to specific cases.

The embodiment of the present application provides a seawater desalination system, which is used for solving the technical problem of low solar energy utilization rate of the existing seawater desalination system.

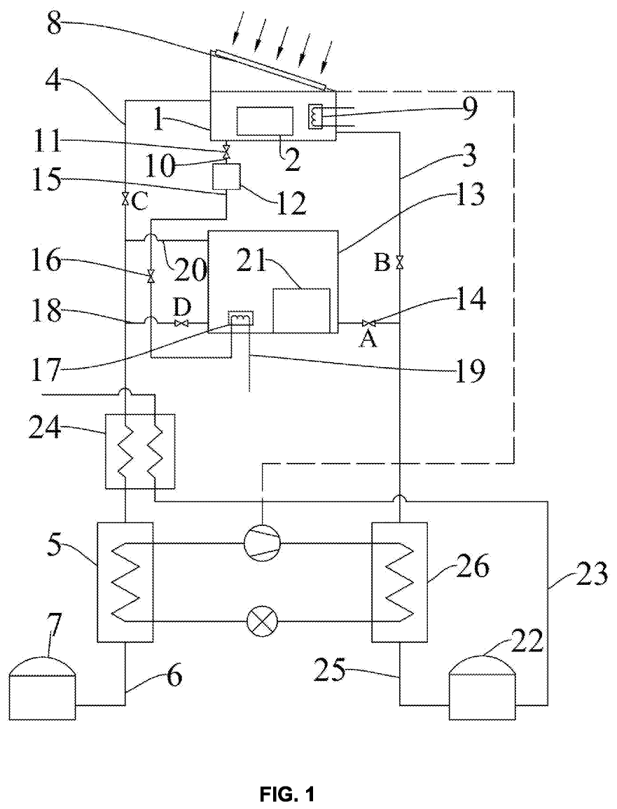

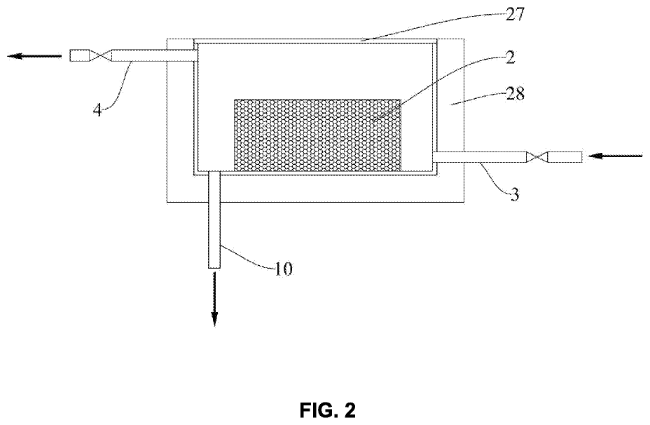

Referring to FIGS. 1 and 2, a structural schematic diagram of a seawater desalination system is provided in accordance with an embodiment of the present application.

The embodiment of the invention provides a first embodiment of a seawater desalination system. The seawater desalination system of the embodiment includes an evaporation tank 1, a heat absorption device 2, a first pipeline 3, a second pipeline 4, a condenser 5, a third pipeline 6, a water tank 7 and a solar cell panel 8. A first closed cavity for containing seawater is provided in the evaporation tank 1, and a first through hole and a second through hole are provided in an inner side wall of the first closed cavity. A light absorption surface 27 of the evaporation tank 1 is made of a high-light-transmission material. A heat absorption device 2 is provided in the evaporation tank 1 and is used for absorbing sunlight with a wavelength of more than 1100 nm. A light inlet of the heat absorption device 2 is provided opposite to the light absorption surface 27 of the evaporation tank 1. A first end of the first pipeline 3 is connected to a liquid supply device of seawater, and a second end of the first pipeline 3 is connected to the first through hole. A first end of the second pipeline 4 is connected to the second through hole, and a second end of the second pipeline 4 is connected to the condenser 5. The second pipeline 4 is used for conveying water vapor evaporated by seawater in the evaporation tank 1. The condenser 5 is connected to the water tank 7 through the third pipeline 6. The solar cell panel 8 is used for providing electric energy for the heat absorption device 2 and the condenser 5.

It should be noted that the number of the light absorption surfaces 27 may be one, two or three, and the light absorption surface 27 may be provided at any position other than a bottom surface of the evaporation tank 1. The light absorption surface 27 may be glass or other light-transmission panel. The position of the heat absorption device 2 may be set according to the position of the light absorption surface 27. The solar cell panel 8 may be provided above the evaporation tank 1 or on a side surface of the evaporation tank 1. The number, materials, and locations of the various components described above are merely exemplary and are not intended to limit the present application. Those skilled in the art will be able to set them as required, which will not be described in detail herein.

The evaporation tank 1 in the present application is internally provided with the first closed cavity used for containing seawater. The inner side wall of the first closed cavity is provided with the first through hole and the second through hole. The light absorption surface 27 of the evaporation tank 1 is made of a high-light-transmission material, which allows the sunlight to be fully transmitted into the evaporation tank 1. The heat absorption device 2 is arranged in the evaporation tank 1 and used for absorbing sunlight with the wavelength of no less than 1100 nm, and the light inlet of the heat absorption device 2 is provided opposite to the light absorption surface 27 of the evaporation tank 1, so that the heat absorption device 2 can absorb sunlight with the wavelength of no less than 1100 nm and evaporate seawater by utilizing the heat of the sunlight with the wavelength of no less than 1100 nm. The first end of the first pipeline 3 is connected to the liquid supply device of seawater, and the second end of the first pipeline 3 is connected to the first through hole. The first end of the second pipeline 4 is connected to the second through hole, and the second end of the second pipeline 4 is connected to the condenser 5. The second pipeline 4 is used for conveying water vapor evaporated by seawater in the evaporation tank 1. The condenser 5 is connected to the water tank 7 through the third pipeline 6. The seawater enters the evaporation tank 1 through the first pipeline 3 to be heated and evaporated and then enters the condenser 5 to be condensed through the second pipeline 4, and finally, the water is collected into the water tank 7, so that water resources can be saved. The solar cell panel 8 is used for providing electric energy for the heat absorption device 2 and the condenser 5. The solar cell panel 8 is used for converting sunlight into electric energy, so that the effect of saving energy can be achieved. Compared with the traditional seawater desalination system, the present application not only utilizes the short wave band in sunlight to provide electric energy for equipment in the system, but also utilizes the long wave band in sunlight, so that the utilization rate of solar energy is effectively improved, and the technical problem that the utilization rate of solar energy is low in the existing seawater desalination system is solved.

The first embodiment of the seawater desalination system provided by the invention has been described in the above context. The second embodiment of the seawater desalination system provided by the present application is provided as follows, with specific reference to FIGS. 1 and 2.

The seawater desalination system in the embodiment includes an evaporation tank 1, a heat absorption device 2, a first pipeline 3, a second pipeline 4, a condenser 5, a third pipeline 6, a water tank 7 and a solar cell panel 8. A first closed cavity for containing seawater is provided in the evaporation tank 1, and a first through hole and a second through hole are provided in an inner side wall of the first closed cavity. A light absorption surface 27 of the evaporation tank 1 is made of a high-light-transmission material. The heat absorption device 2 is disposed in the evaporation tank 1 and is used for absorbing sunlight with a wavelength of no less than 1100 nm. A light inlet of the heat absorption device 2 is provided opposite to the light absorption surface 27 of the evaporation tank 1. A first end of the first pipeline 3 is connected to a liquid supply device of seawater, and a second end of the first pipeline 3 is connected to the first through hole. A first end of the second pipeline 4 is connected to the second through hole, and a second end of the second pipeline 4 is connected to the condenser 5. The second pipeline 4 is used for conveying water vapor evaporated by seawater in the evaporation tank 1. The condenser 5 is connected to the water tank 7 through the third pipeline 6. The solar cell panel 8 is used for providing electric energy for the heat absorption device 2 and the condenser 5.

In particular, it is also possible to provide a stop valve B on the first pipeline 3 and a stop valve C on the second pipeline 4. In the daytime, the stop valve B and the stop valve C are opened. The solar cell panel 8 provides electric energy for the heat absorption device 2 and the condenser 5. The heat absorption device 2 absorbs sunlight with the wavelength of no less than 1100 nm. The seawater enters the evaporation tank 1 through the first pipeline 3, while the heat absorption device 2 heats the seawater by utilizing the absorbed heat. The seawater is heated and evaporated to become water vapor, and the water vapor enters the condenser 5 through the second pipeline 4 to be condensed. The water tank 7 collects the condensed water vapor.

It should be noted that it is also possible to provide a first insulating layer 28 on an outside of the evaporation tank 1, so that the evaporation tank 1 has good sealing property and thermal insulation. The first insulating layer 28 may be an aerogel blanket or rock wool. Those skilled in the art will be able to arrange it as required, which will not be described in detail herein.

It will be understood that, with the heat pump technology, the liquid refrigerant with low temperature and low pressure can absorb the heat of the water vapor entering the condenser 5, thereby achieving the effect of condensing the water vapor.

Further, referring to FIG. 1, there is further included a first heater 9 which is provided in the evaporation tank 1 and externally connected with a power source. The first heater 9 can be powered on when sunlight is insufficient in the daytime, and the heat of the first heater 9 is utilized to heat and evaporate seawater. Of course, the first heater 9 may be provided at any position within the evaporation tank 1, and those skilled in the art may make appropriate changes on the basis of the position in FIG. 1, which will not be specifically described herein.

Further, referring to FIG. 1, there is further included a fourth pipeline 10, a first controller 11, and a first liquid storage tank 12. The inner side wall of the first closed cavity is provided with a third through hole. The first end of the fourth pipeline 10 is connected to the third through hole, and the second end of the fourth pipeline 10 is connected to the first liquid storage tank 12. The first controller 11 is arranged on the fourth pipeline 10 and is used for controlling the opening and closing of the fourth pipeline 10. When the seawater in the evaporation tank 1 is not fully evaporated, the first controller 11 can be started, and the seawater which is not evaporated in the evaporation tank 1 is collected by the first liquid storage tank 12, so that the capacity of seawater in the evaporation tank 1 can be reduced, thereby improving the efficiency of evaporation of seawater.

It should be noted that the outside of the first liquid storage tank 12 may be provided with a heat-insulating material so as to maintain the temperature inside the first liquid storage tank 12. Of course, the heat-insulating material may be glass fiber or asbestos. The first controller 11 may be a stop valve or a pump. Those skilled in the art will be able to set them as required, which will not be described in detail herein.

Further, referring to FIG. 1, there is further included a heat storage tank 13, a fifth pipeline 14, a sixth pipeline 15, a second controller 16, a first heat exchanger 17 and a seventh pipeline 18. A second closed cavity for containing seawater is provided in the heat storage tank 13, and a fourth through hole, a fifth through hole and a sixth through hole are provided in an inner side wall of the second closed cavity. A first end of the fifth pipeline 14 is connected to the liquid supply device, and a second end of the fifth pipeline 14 is connected to the fourth through hole. A first end of the sixth pipeline 15 is connected to the first liquid storage tank 12, and a second end of the sixth pipeline 15 is connected to the fifth through hole. The second controller 16 is arranged on the sixth pipeline 15 and used for controlling the opening and closing of the sixth pipeline 15. The first heat exchanger 17 is provided in the heat storage tank 13 and is connected to the fifth through hole and used for conducting heat of seawater in the sixth pipeline 15 to the heat storage tank 13. A first end of the seventh pipeline 18 is connected to the sixth through hole, and a second end of the seventh pipeline 18 is connected to the condenser 5. The seventh pipeline 18 is used for conveying water vapor evaporated by seawater in the heat storage tank 13.

In particular, it is also possible to provide a stop valve A on the fifth pipeline 14 and a stop valve D on the seventh pipeline 18. At night, the stop valve B and the stop valve C are closed, the stop valve A and the stop valve D are opened, and the second controller 16 is started, and seawater enters the heat storage tank 13 through the fifth pipeline 14. The seawater which is not evaporated in the first liquid storage tank 12 enters the first heat exchanger 17 through the sixth pipeline 15, and the first heat exchanger 17 conducts heat of the seawater in the sixth pipeline 15 to the heat storage tank 13. The seawater in the heat storage tank 13 is heated by utilizing the heat of the seawater in the sixth pipeline 15, and the seawater in the heat storage tank 13 is heated and evaporated into water vapor. The water vapor enters the condenser 5 through the seventh pipeline 18 to be condensed, the seawater in the heat storage tank 13 is heated by utilizing the heat of the seawater in the first liquid storage tank 12, and the effects of fully utilizing the heat and saving energy are achieved.

It is to be noted that the outside of the heat storage tank 13 may be provided with a heat-insulating material so as to maintain the temperature inside the heat storage tank 13. Of course, the heat-insulating material may be glass fiber or asbestos. The second controller 16 may be a stop valve or a pump. Those skilled in the art will be able to set them as required, which will not be described in detail herein.

Further, referring to FIG. 1, an eighth pipeline 19 is included. A seventh through hole is provided in the inner side wall of the second closed cavity, and the eighth pipeline 19 is connected to the first heat exchanger 17 through the seventh through hole and used for discharging the seawater in the sixth pipeline 15. The seawater in the sixth pipeline 15 is discharged through the eighth pipeline 19 after being conducted and thermally exchanged through the first heat exchanger 17, so that the working efficiency of the first heat exchanger 17 can be improved, and the utilization rate of heat is improved.

Further, referring to FIG. 1, a ninth pipeline 20 and a heat storage device 21 are further included. An eighth through hole is provided in the inner side wall of the second closed cavity. A first end of the ninth pipeline 20 is connected to the second pipeline 4, and a second end of the ninth pipeline 20 is connected to the eighth through hole. The heat storage device 21 is provided in the heat storage tank 13 and used for absorbing heat of water vapor, and the seawater in the heat storage tank 13 is heated and evaporated by using the absorbed heat.

It should be noted that the heat storage device 21 is composed of a heat storage material, and the heat storage material may be a phase changing material. Those skilled in the art will be able to set it as required, which will not be described in detail herein.

Specifically, during the daytime, the stop valve B and the stop valve C are opened, while the stop valve A and the stop valve D are closed. After seawater is evaporated into water vapor in the evaporation tank 1, the water vapor enters the heat storage tank 13 through the second pipeline 4 and the ninth pipeline 20. The heat of the water vapor is absorbed by the heat storage device 21. At night, the stop valve B and the stop valve C are closed, and the stop valve A and the stop valve D are opened. The heat storage device 21 releases the heat absorbed in the daytime, so that the seawater in the heat storage tank 13 is heated and evaporated. The heat storage device 21 does not need to be electrified, and the heat is just absorbed through the heat storage material. The heat of the water vapor not only can be fully utilized, but also the electric energy can be saved.

Further, referring to FIG. 1, the liquid supply device includes a second liquid storage tank 22 and a tenth pipeline 23. A water outlet of the second liquid storage tank 22 is connected to the first end of the first pipeline 3, and a first end of the tenth pipeline 23 is connected to a water inlet of the second liquid storage tank 22. Seawater enters the second liquid storage tank 22 through the tenth pipeline 23. The seawater firstly stands in the second liquid storage tank 22 and then enters the evaporation tank 1 through the first pipeline 3, so that solid impurities in the seawater can be prevented from entering other equipment in the system and influencing the working of the equipment.

Further, referring to FIG. 1, a second heat exchanger 24 is further included. A first end of the second heat exchanger 24 is connected to a second end of the tenth pipeline 23, and a second end of the second heat exchanger 24 is connected to an input end of the condenser 5, for conducting the heat of the water vapor before entering the condenser 5 to the seawater in the tenth pipeline 23. The seawater is preheated by the heat of the water vapor before entering the condenser 5, so that not only energy can be saved, but also thermal contamination can also be reduced by reducing heat.

Further, referring to FIG. 1, there is also included an eleventh pipeline 25 and a second heater 26. A first end of the eleventh pipeline 25 is connected to the second liquid storage tank 22, and an input end of the second heater 26 is connected to a second end of the eleventh pipeline 25. An output end of the second heater 26 is connected to the first end of the first pipeline 3.

It will be appreciated that, the use of heat pump technology allows a liquid refrigerant with low temperature and low pressure to absorb heat in the condenser 5 and be vaporized into a low pressure vapor which is compressed by a compressor in the heat pump system into a vapor with high temperature and high pressure. The vapor with high temperature and high pressure is used to heat seawater in the eleventh pipeline 25 in the second heater 26.

Further, referring to FIGS. 1 and 2, the solar cell panel 8 is provided above the evaporation tank 1. A back plate of the solar cell panel 8 is made of a high-light-transmission material. The back plate of the solar cell panel 8 is provided opposite to the light absorption surface 27 of the evaporation tank 1, and the back plate of the solar cell panel 8 is made of a high-light-transmission material, so that sunlight can be transmitted through the solar cell panel 8 to prevent the sunlight from accumulating heat on the back plate of the solar cell panel 8. The back plate of the solar cell panel 8 is opposite to the light absorption surface 27 of the evaporation tank 1, so that sunlight can be transmitted through the back plate of the solar cell panel 8 and irradiate on the evaporation tank 1, and the heat absorption device 2 in the evaporation tank 1 can absorb sunlight with the wavelength of no less than 1100 nm.

As described above, the above embodiments are merely illustrative of the technical solutions of the present application without limiting thereof. Although the present application has been described in detail with reference to the foregoing embodiments, those skilled in the art will appreciate that: the technical solutions of the above-mentioned embodiments can still be modified, or some of the technical features thereof can be equivalently replaced. These modifications and substitutions do not make the essence of the corresponding technical solutions depart from the spirit and scope of the technical solutions of various embodiments of this application.

What is claimed is:

1. A seawater desalination system comprising:
an evaporation tank having a light absorption surface made of a high-light transmission material and a first closed cavity for containing seawater being provided in the evaporation tank, the first close cavity having a first through hole and a second through hole provided in an inner side thereof;
a heat absorption device provided in the evaporation tank and being used to absorb sunlight with a wavelength of no less than 1100 nm, the heat absorption device having a light inlet provided opposite the light absorption surface of the evaporation tank;
a first pipeline having a first end connected to a liquid supply device of seawater and a second end connected to the first through hole;
a second pipeline having a first end connected to the second through hold and a second end, the second pipeline conveying water vapor evaporated by seawater in the evaporation tank
a condenser connected at one end to the second end of the second pipeline and to a first end of a third pipeline;
a water tank connected to a second end of the third pipeline, and
a solar cell panel positioned adjacent the light absorption surface for providing electric energy for the heat absorption device and the condenser.

2. The seawater desalination system of claim 1, further comprising a first heater provided in the evaporation tank and externally connected with a power supply.

3. The seawater desalination system of claim 1, further comprising:
a fourth pipeline having a first end and a second end, wherein the first close cavity further comprises a third through hole, said first end of the fourth pipeline being connected to the third through hole;
a first controller arranged on the fourth pipeline and configured to control opening and closing of the fourth pipeline and
a first liquid storage tank connected to the second end of the fourth pipeline.

4. The seawater desalination system of claim 3, further comprising:
a heat storage tank having a second closed cavity for containing seawater, the second closed cavity having an inner side wall and a fourth through hole, a fifth through hole and a sixth through hold provided in the inner side wall;
a fifth pipeline having a first end and a second end, the first end of the fifth pipeline being connected to the liquid supply device, the second end of the fifth pipeline being connected to the fourth through hole;
a sixth pipeline having a first end connected to the first liquid storage tank, and a second end connected to the fifth through hole;
a second controller arranged on the sixth pipeline and configured to control opening and closing of the sixth pipeline;
a first heat exchanger provided in the heat storage tank and being connected to the fifth through hole, the first heat exchanger conducting heat of seawater in the sixth pipeline to the heat storage tank; and
a seventh pipeline having a first end connected to the sixth through hole, and a second end connected to the condenser, the seventh pipeline being used for conveying water vapor evaporated by seawater in the heat storage tank.

5. The seawater desalination system of claim 4, further comprising:
an eighth pipeline; and
a seventh through hole being provided in the inner side wall of the second closed cavity;
wherein the eighth pipeline is connected to the first heat exchanger through the seventh through hole and used for discharging seawater in the sixth pipeline.

6. The seawater desalination system of claim 4, further comprising:
a ninth pipeline having a first end connected to the second pipeline, and a second end;
a heat storage device provided in the heat storage tank and configured to absorb heat of the water vapor and seawater in the heat storage tank being heated and evaporate by using the absorbed heat; and
an eighth through hole being provided in the inner side wall of the second closed cavity and being connected to the second end of the ninth pipeline.

7. The seawater desalination system of claim 4, wherein the liquid supply device comprises:
a second liquid storage tank having a water inlet, and a water outlet connected to the first end of the first pipeline; and
a tenth pipeline having a first end connected to the water inlet;

8. The seawater desalination system of claim 7, further comprising:
a second heat exchanger having a first end connected to a second end of the tenth pipeline, and a second end being connected to an input end of the condenser,
the second heat exchanger conducting heat of water vapor before entering the condenser to seawater in the tenth pipeline.

9. The seawater desalination system of claim 7, further comprising:
an eleventh pipeline having a first end connected to the second liquid storage tank and a second end; and
a second heater having an input connected to the second end of the eleventh pipeline, and an output connected to the first end of the first pipeline.

10. The seawater desalination system of claim 1, wherein the solar cell panel is provided above the evaporation tank and includes a back plate made of the high-light-transmission material and being provided opposite to the light absorption surface of the evaporation tank.
